(19) United States
(12) Patent Application Publication
(10) Pub. No.: US 2023/0112225 A1
(43) Pub. Date: Apr. 13, 2023

(54) VIRTUAL MACHINE REMOTE HOST MEMORY ACCESSES

(71) Applicant: Nutanix, Inc., San Jose, CA (US)

(72) Inventors: Felipe FRANCIOSI, Cambridge (GB); Jonathan James DAVIES, Cambridge (GB)

(73) Assignee: Nutanix, Inc., San Jose, CA (US)

(21) Appl. No.: 17/710,342

(22) Filed: Mar. 31, 2022

Related U.S. Application Data
(60) Provisional application No. 63/262,488, filed on Oct. 13, 2021.
(60) Provisional application No. 63/263,807, filed on Nov. 9, 2021.
(60) Provisional application No. 63/264,540, filed on Nov. 24, 2021.

(51) Int. Cl. G06F 9/455

(52) U.S. Cl. CPC G06F 9/45558; G06F 2009/4557; G06F 2009/45583

(57) ABSTRACT

Techniques for migrating a virtual machine from a source node to a target node. A source node hosting a virtual machine is interconnected over a hardware-assisted interconnection fabric to a target node that is configured to receive all or portions of a to-be-migrated virtual machine. During migration, some portions of the virtual machine's memory contents might be at the source node, whereas other portions of the virtual machine's memory might be at the target node. When a CPU is processing a next instruction of a first virtual machine running on a source node, then rather than accessing physical memory of the source node, instead using the hardware-assisted interconnection fabric to fetch the next instruction from the target node. CPUs that are executing virtual machine code at either the source node or the target node can fetch instructions from memory at either node, or from memory of the hardware-assisted interconnection fabric.

### RELATED APPLICATIONS

The present application claims the benefit of priority to U.S. Patent Application Ser. No. 63/262,488 titled “VIRTUAL MACHINE REMOTE HOST MEMORY ACCESSES” filed on Oct. 13, 2021, which is hereby incorporated by reference in its entirety; and the present application claims the benefit of priority to U.S. Patent Application Ser. No. 63/263,807 titled “VIRTUAL MACHINE REMOTE HOST MEMORY ACCESSES” filed on Nov. 9, 2021, which is hereby incorporated by reference in its entirety; and the present application claims the benefit of priority to U.S. Patent Application Ser. No. 63/264,540 titled “VIRTUAL MACHINE MIRRORING AND REPLICATION USING REMOTE PCIE INTERCONNECTIONS” filed on Nov. 24, 2021, which is hereby incorporated by reference in its entirety; and the present application is related to U.S. patent application Ser. No. ______ titled “VIRTUAL MACHINE REPLICATION USING HOST-TO-HOST PCIE INTERCONNECTIONS” (Attorney Docket No. NUT-PAT-1292), filed on even date herewith, which is hereby incorporated by reference in its entirety.

### TECHNICAL FIELD

This disclosure relates to high performance virtual machine memory management, and more particularly to techniques for virtual machine remote host memory accesses.

### BACKGROUND

Live migrating virtual machines (VMs) is a fundamental operation in the virtualization industry. Live migration includes transferring (e.g., over a network) a VM's state, including memory contents, between a physical source host and a physical destination host. Transferring the VM's memory is the most challenging part of the state to transfer. This is due to the fact that the bandwidths available between a CPU and memory is much greater than bandwidths available over networks. In other words, local memory can be modified much faster than it can be copied to a remote location over a network.

As a result, two techniques (or a combination of them) are commonly used. One is called “pre-copy live migration” where memory modified at the source is iteratively copied to the destination until both states are relatively equivalent. Another is called “post-copy live migration” where a VM state is moved, but all or some of the memory is left behind in the source host and is migrated at a later stage.

Both of these models have fundamental limitations. Pre-copy results in unnecessary data transfers (due to repeated iterations) and often requires the VM to be slowed down (or stunned) at the source to guarantee convergence. Post-copy results in performance degradation once the VM is at the destination due to fault handling of memory. It also requires that the overall VM state exists partially in one physical location and partially in another physical location (e.g., spanning two different nodes), meaning that a failure in either location or a failure of the network to provide access to the locations can result in loss of data.

Unfortunately, the foregoing limitations lead to non-optimal performance of virtual machines in a multi-node environment.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result. Described herein are techniques that address handling virtual machine instruction fetch operations on a first computing node when the instructions and data to be fetched are actually in the physical memory of a second, different computing node.

The present disclosure describes techniques used in systems, methods, and in computer program products for virtual machine remote host memory accesses, which techniques advance the relevant technologies to address technological issues with legacy approaches. More specifically, the present disclosure describes techniques used in systems, methods, and in computer program products for virtual machine remote host memory accesses. Certain embodiments are directed to technological solutions for accessing virtual machine instruction via an actual direct access to memory of a remote node that holds the instruction to be fetched.

The disclosed embodiments modify and improve over legacy approaches. In particular, the herein-disclosed techniques provide technical solutions that address the technical problems attendant to handling a virtual machine instruction fetch operation when the instruction to be fetched is in physical memory of a remote node. Such technical solutions involve specific implementations (e.g., data organization, data communication paths, module-to-module interrelationships, etc.) that relate to the software arts for improving computer functionality. Various applications of the herein-disclosed improvements in computer functionality serve to reduce demand for computer memory, reduce demand for computer processing power, reduce network bandwidth usage, and reduce demand for intercomponent communication.

For example, when performing computer operations involving memory of two (or more) nodes, rather than carrying out a process-to-driver-to-hardware-to-hardware-to-driver-to-process protocol for copying memory (e.g., memory words or memory pages), instead, specialized hardware is deployed to facilitate a process-to-hardware-to-hardware-to-process protocol for copying memory words or pages. As such, nearly all of the latency that would be incurred when a process interacts with a driver is eliminated for virtually all types of memory accesses. Instead of copying memory pages from a source node to a target node (e.g., as is the case for RDMA-oriented transactions), a CPU of a source node can execute a remote node machine instruction by actually directly accessing the memory of the remote node that holds the subject machine instruction. Moreover, use of the aforementioned specialized hardware eliminates the need for specific programming to accomplish remote data access. Instead, such specialized hardware can, once its mapping hardware is configured, perform remote access to the memory of the target node in a manner that is not only transparent to the software, but also is performed in a manner that allows the CPU to be oblivious to the actual location of the memory being accessed.

The ordered combination of steps of the embodiments serve in the context of practical applications that perform steps for accessing a virtual machine instruction via an actual direct access to memory of a remote node that holds the instruction to be fetched. As such, techniques for accessing a virtual machine instruction via an actual direct access to memory of a remote node that holds the instruction to be fetched overcome long-standing yet heretofore unsolved technological problems that arise in the realm of computer systems.

Many of the herein-disclosed embodiments for accessing a virtual machine instruction via an actual direct access to memory of a remote node that holds the instruction to be fetched are technological solutions pertaining to technological problems that arise in the hardware and software arts that underlie virtualization systems and/or computing clouds. Aspects of the present disclosure achieve performance and other improvements in peripheral technical fields including, but not limited to, hyperconverged computing platform management and computing cluster management.

Some embodiments include a sequence of instructions that are stored on a non-transitory computer readable medium. Such a sequence of instructions, when stored in memory and executed by one or more processors, causes the one or more processors to perform a set of acts for accessing virtual machine data via an actual direct access to memory of a remote node that holds the data to be fetched.

Some embodiments include the aforementioned sequence of instructions that are stored in a memory, which memory is interfaced to one or more processors such that the one or more processors can execute the sequence of instructions to cause the one or more processors to implement acts for accessing a virtual machine instruction via an actual direct access to memory of a remote node that holds the instruction to be fetched.

In various embodiments, any combinations of any of the above can be organized to perform any variation of acts for virtual machine remote host memory accesses, and many such combinations of aspects of the above elements are contemplated.

Further details of aspects, objectives and advantages of the technological embodiments are described herein, and in the figures and claims.

### BRIEF DESCRIPTION OF THE DRAWINGS

The drawings described below are for illustration purposes only. The drawings are not intended to limit the scope of the present disclosure. This patent or application file contains at least one drawing executed in color. Copies of this patent or patent application publication with color drawings will be provided by the U.S. Patent and Trademark Office upon request and payment of the necessary fee.

FIG. 1A1 and FIG. 1A2 depict virtualization system environments that support remote host direct memory accesses by a virtual machine, according to an embodiment.

FIG. 1B shows a flowchart depicting an example virtual machine migration technique that supports actual remote host direct memory accesses by a virtual machine during various migration phases, according to an embodiment.

FIG. 1C depicts a source-side virtual machine memory mapping technique that supports remote host direct memory accesses by a virtual machine, according to an embodiment.

FIG. 1D depicts alternative virtual machine migration techniques that support remote node direct memory accesses by a virtual machine running on a local node, according to an embodiment.

FIG. 1E depicts a target-side virtual machine memory mapping technique that supports remote host direct memory accesses by a virtual machine, according to an embodiment.

FIG. 2 depicts a source-side virtual machine memory reclaiming technique, according to an embodiment.

FIG. 3A depicts a hardware-assisted remote host direct memory access technique that supports mapping from a local host virtual machine memory address to a remote host virtual machine memory address, according to an embodiment.

FIG. 3B shows a flowchart depicting a hardware-assisted page copy technique, according to an embodiment.

FIG. 4 depicts cross-host virtual machine memory mappings, according to an embodiment.

FIG. 5A, FIG. 5B, FIG. 5C, and FIG. 5D depict virtualization system architectures comprising collections of interconnected components suitable for implementing embodiments of the present disclosure and/or for use in the herein-described environments.

### DETAILED DESCRIPTION

Aspects of the present disclosure solve problems associated with using computer systems for handling a virtual machine instruction fetch operation when the instruction to be fetched is in physical memory of a remote node. Some embodiments are directed to approaches for accessing a virtual machine instruction via an actual direct access to memory of a remote node that holds the instruction to be fetched. The accompanying figures and discussions herein present example environments, systems, methods, and computer program products for virtual machine remote host memory accesses.

### Overview

This innovation combines software and hardware technologies to provide significant improvements to live migration of virtual machines. Specifically, various capabilities are brought to bear by specialized hardware in multi-node computing clusters. The herein-disclosed techniques allow a CPU at a one computing node to execute VM instructions that are actually resident at another computing node. This avoids the drawbacks of the aforementioned approaches.

As used herein a computing node is a particular type of operational element having at least one CPU and at least some amount of local memory that hosts virtualization system software (e.g., a hypervisor, a virtual machine, virtual devices, etc.). In some situations multiple computing nodes are organized into a computing cluster wherein the multiple computing nodes are interconnected such that the multiple computing nodes share a contiguous address space. In exemplary embodiments, the multiple computing nodes are each connected to specialized hardware for communication between operational elements of the computing cluster.

In some embodiments, the aforementioned specialized hardware implements a specific inter-node protocol for rendering a CPU oblivious as to where the contents of accessed memory is actually located. In some cases, the CPU is oblivious that the contents of some accessed memory address is actually stored in RAM of a different node than the node that hosts the oblivious CPU. In some embodiments a CXL.memory protocol leverages the physical and electrical interfaces of any peripheral component interconnect express (PCIe) components.

In some embodiments, software composable infrastructure (SCI) is employed to configure operational elements of a multi-node computing cluster. SCI is a technology that supports peripheral component interconnect (PCI) devices (e.g., PCIe components) and/or CXL components and/or other hardware components, which in turn allows remotely-situated devices (e.g., memory) to be accessed from a remote node as if it were local. SCI uses specialized computing infrastructure. These technologies can be used singly or as combined to enhance VM live migration in the ways discussed below.

### Virtual Machine Migration Use Model 1

The disclosed technology allows the memory state of the VM to be transferred to the destination host while the VM is still executing at the source host. Moreover, transferring the memory state of a VM of a source host to a destination host incurs minimal to no impact on performance as compared to accessing the memory of the source host. Once all of the memory state of the VM on the source node has been transferred to the destination host, execution of the VM can be switched over to the destination host. This differs from, and significantly improves upon, other approaches, at least because the data (e.g., the state of the VM) only has to be transferred once and it is thereafter accessed remotely until all of the memory state of the VM on the source node has been transferred to the destination host.

### Virtual Machine Migration Use Model 2

The disclosed technology allows the VM to be migrated to a destination host while the VM's memory, or portions of it, remains at the source host. At this initial point in time, all memory accesses from the VM at the destination host are remote accesses back to the source host. Over time, the memory at the source host can then be asynchronously transferred to the destination host (e.g., on demand) as the VM executes at the destination host. This differs from, and significantly improves upon, legacy post-copy techniques, at least because accesses on the destination host do not need to incur a fault or trap followed by a post-copy page transfer (e.g., using network protocols or RDMA links).

The foregoing virtual machine migration use models are merely illustrative examples and many other virtual machine use models are supported via implementation of the herein-disclosed techniques. Strictly as one such example, the herein-disclosed techniques can be used for virtual machine mirroring. To illustrate, the herein-disclosed techniques support memory copying between an active VM and a standby VM. Such copying is done using specialized hardware-containing computing infrastructure so as to avoid incurring noticeable performance impacts. In some mirroring scenarios, once the active VM has been copied to the standby VM, the mirroring can be maintained continually over an arbitrarily long period of time. A cutover to the standby VM can be initiated at will (e.g., in the event of a loss of function of the active VM and/or its underlying computing equipment).

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

As used herein, the terms “CXL component” or “CXL components” or “CXL.memory component” or “CXL.memory components” or “CXL device” or “CXL devices” or “CXL.memory device” or “CXL.memory devices” refer to a hardware-containing computing infrastructure that implements advanced CPUs, devices and device interconnect, and memory protocols. Such a component may contain and/or refer to some amount of volatile memory and/or some amount of persistent memory. In some configurations, a CXL.memory controller is enumerated as a PCIe device. In some configurations, pairs of CXL.memory controllers are situated in different nodes so as to facilitate cross-host memory operations (e.g., memory coherency) over a cross-host hardware link.

The physical address space of a first portion of memory on a first virtual machine host computer may be different from a corresponding physical address in a second virtual machine host computer, even though the two physical addresses have mirrored contents. For example, the contents of memory at physical address x00001000 at the first virtual machine host computer can be copied to the second virtual machine host computer so as to make the contents of memory at physical address x00002000 at the second virtual machine host computer be the same as the contents of memory at physical address x00001000 at the first virtual machine host computer. As pertaining to CPU execution of an instruction, when a CPU of the first virtual machine host computer initiates a memory read operation (e.g., an instruction FETCH operation) prior to execution of the corresponding (e.g., to be FETCHed) instruction in the address space of the virtual machine of first virtual machine the CPU of the first virtual machine host computer actually loads into its instruction register, the contents of a different, second virtual machine of the second virtual machine host computer. As such, the presence of said specialized hardware device between two different virtual machine host computers supports remote host direct memory accesses to memory of a remote host virtual machine by a virtual machine situated on a local host computer.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

### Descriptions of Example Embodiments

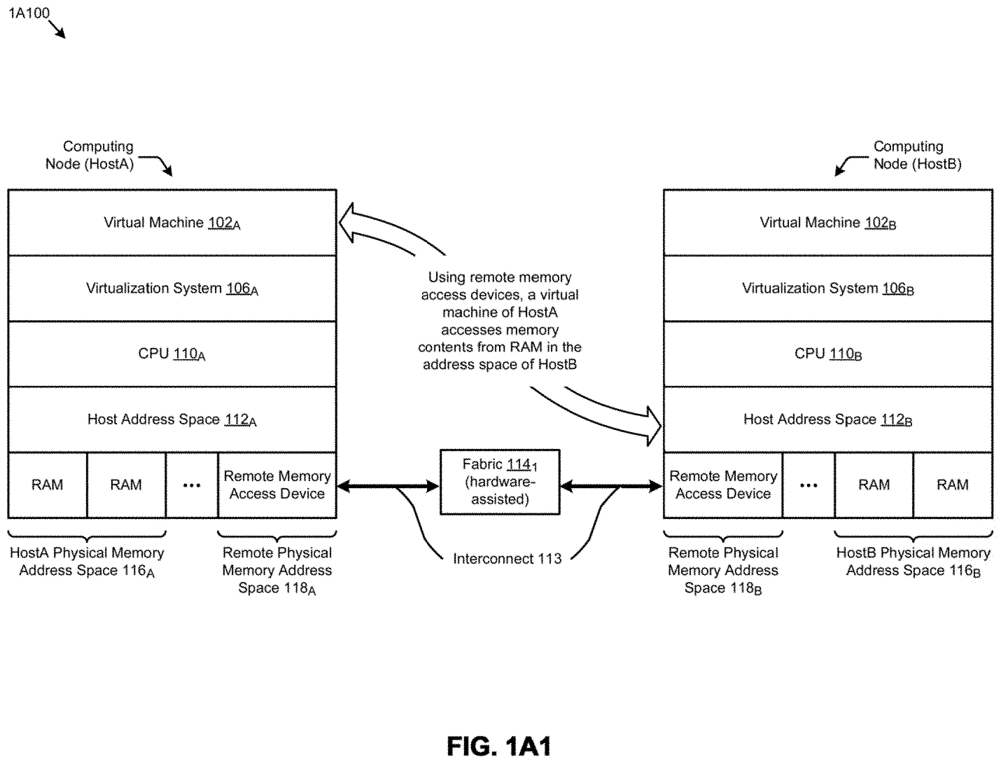

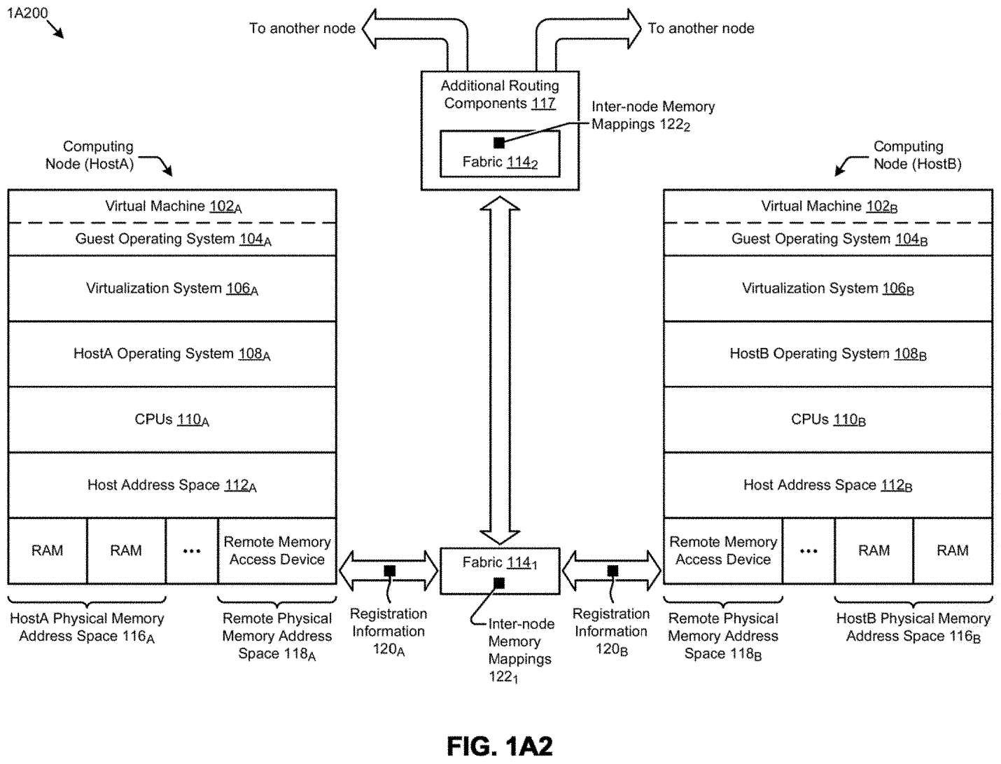

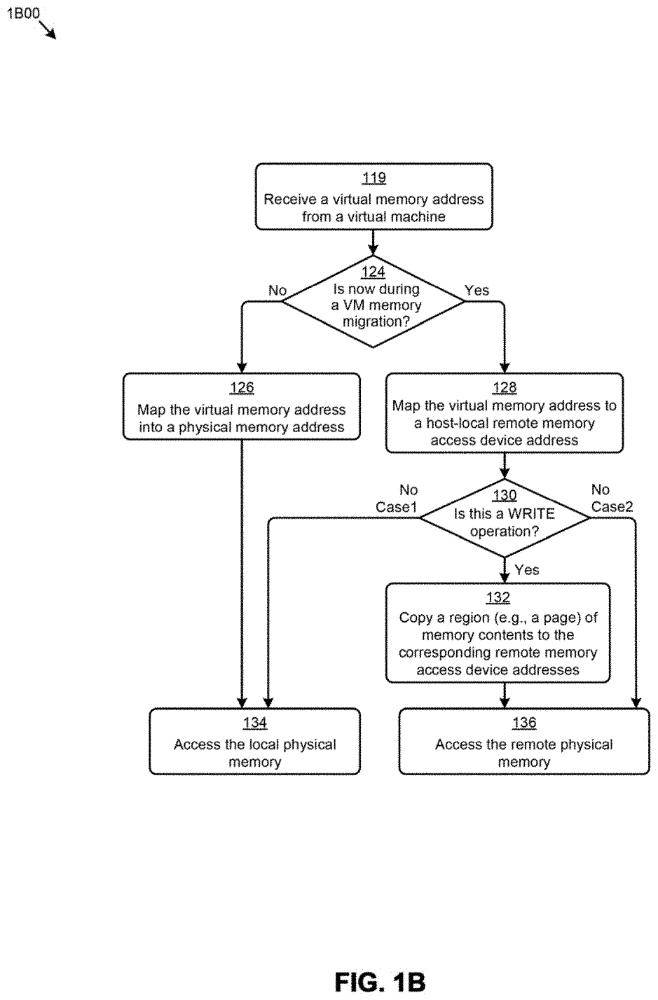

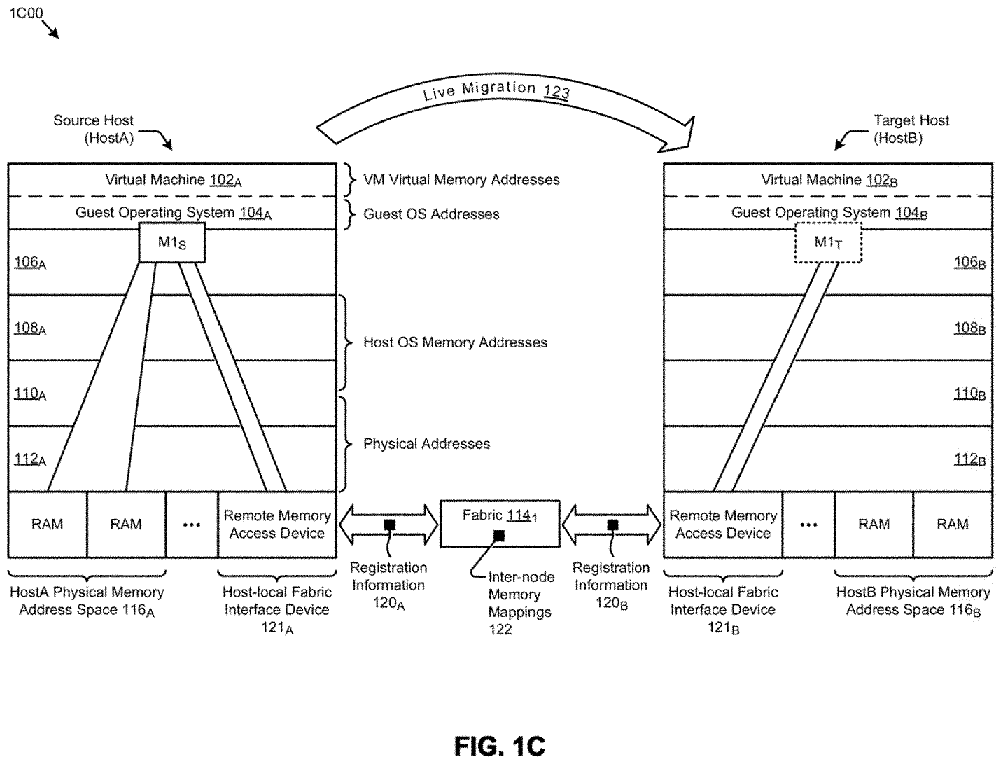

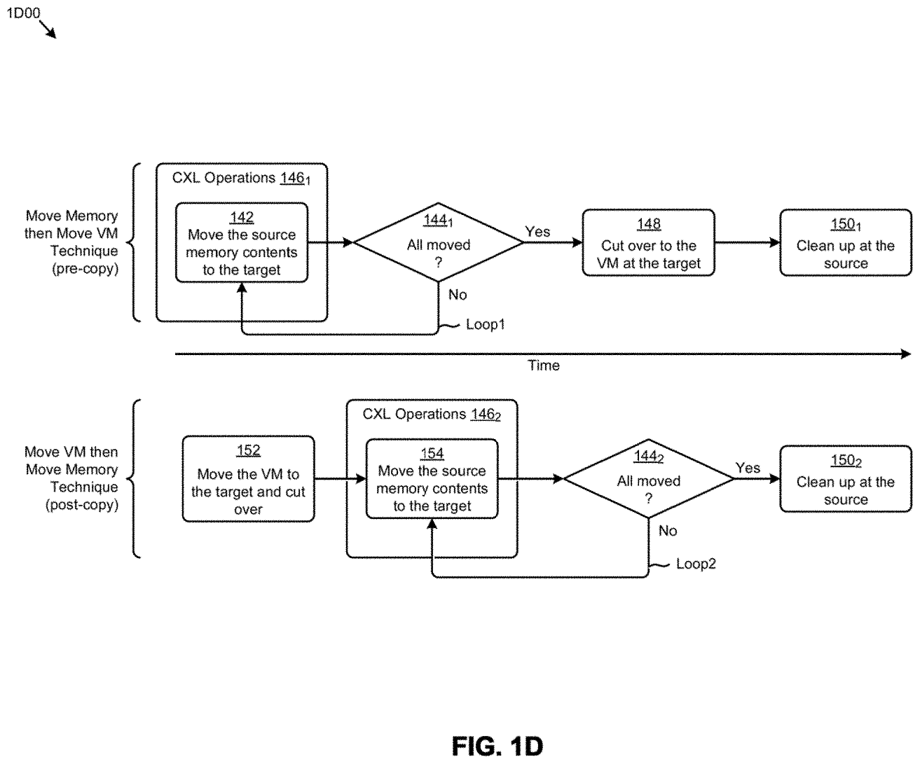

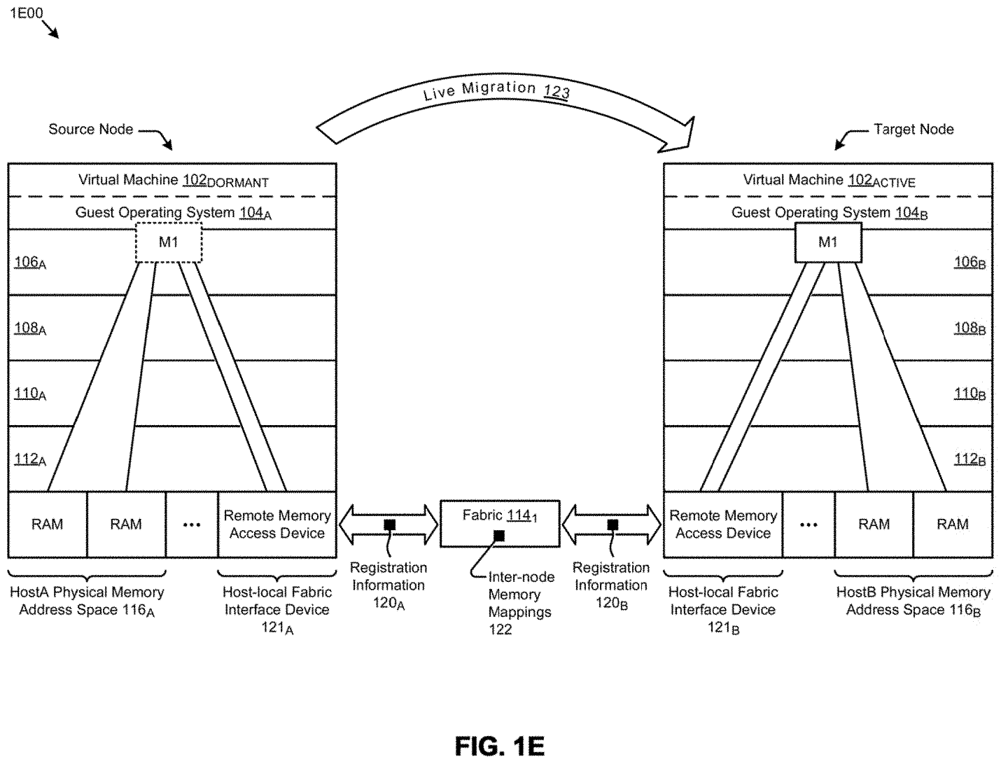

FIG. 1A1 depicts a virtualization system environment 1A100 that supports remote host direct memory accesses by a virtual machine.

As shown the environment includes two computing nodes, HostA and HostB, each of which are configured to support virtualization system software (e.g., virtualization system 106_{A}, virtualization system 106_{B}) that facilitates execution of a virtual machine (VM). The left side of the figure shows how a virtual machine (virtual machine 102_{A}) has underlying virtual memory within host address space 112_{A} (e.g., an address space from address “0” through address “2\hat{ }57-1”), a first portion of which address space corresponds to physical memory (e.g., RAM that comprises HostA physical memory address space 116_{A}), and a second portion of which address space corresponds to a remote memory access device (e.g., remote physical memory address space 118_{A}).

The right side of the figure shows how a virtual machine (virtual machine 102_{B}) has an underlying virtual memory within host address space 112_{B} (e.g., an address space from address “0” through address “2\hat{ }57-1”), a first portion of which address space corresponds to physical memory (e.g., RAM that comprises HostB physical memory address space 116B), and a second portion of which address space corresponds to a remote memory access device (e.g., remote physical memory address space 118B).

As shown, HostA and HostB are interconnected to and by fabric 114₁ over interconnect 113. This interconnection fabric comprises specialized hardware that permits a CPU of a first system (e.g., CPU 110_{A}) to access data and/or instructions from the memory of a second system. When configured for bi-directional access, this interconnection fabric further permits a CPU of the second system (e.g., CPU 110_{B}) to access data and/or instructions from the memory of the first system.

As regards to memory mapping between virtual memory and physical memory, a first portion of virtual memory M1 is mapped to a first portion (e.g., low memory) of the host's address space, and a second portion of virtual memory M1 is mapped to a second portion (e.g., high memory) of the host's address space. In this example, the first portion (e.g., low memory) of the address space corresponds to physical memory (shown as RAM), whereas the second portion (e.g., high memory) of the address space corresponds to a remote memory access.

The remote memory access device operates as follows: When the VM on HostA accesses an address of the second portion (e.g., corresponding to a remote memory access device), that address is mapped to a location in the address space of HostB. The hardware—specifically, the hardware of the remote memory access device at HostA, the hardware of the fabric device, and the hardware of the remote memory access device at HostB—cooperate such that the CPU of HostA is oblivious to the fact that accesses (e.g., via virtual machine execution at HostA) to an address of the second portion (e.g., corresponding to the remote memory access device of HostA) is actually satisfied by accessing physical memory in the physical address space of HostB. This can be true for any type of memory access, specifically CPU instruction fetches, CPU READ operations, CPU WRITE operations, and CPU READ-MODIFY-WRITE operations.

As such, since the CPU of HostA is oblivious to the fact that its memory accesses are actually satisfied by accessing physical memory of the address space of HostB, it follows that the VM of HostA is also oblivious to the fact that its memory accesses are actually satisfied by accessing physical memory of the physical address space of HostB. The fact that HostA is oblivious to how its memory accesses are actually satisfied (e.g., by accessing mapped-to physical memory of the address space of a different host) is a fact that can be exploited in virtualization systems. FIG. 1A2 depicts a virtualization system environment that supports both a host operating system and a guest operating system, both of which support their own respective memory mapping mechanisms.

FIG. 1A2 depicts a virtualization system environment 1A200 that supports remote host direct memory accesses by a virtual machine. In addition to the elements shown and described as pertains to FIG. 1A1, the virtualization system environment 1A200 includes instances of a guest operating system (e.g., guest operating system 104_{A} and guest operating system 104_{B}) as well as instances of a host operating system (e.g., host operating system 108A and host operating system 108_{B}). The virtualization system at each node can configure remote-memory mappings (e.g., inter-node memory mappings 122₁) into its node-resident host operating system and/or into any memory mapping hardware (e.g., translation lookaside buffers (TLBs)) that is or are accessible to the host operating system (or its agents), or accessible to the guest operating system (or its agents), or accessible to virtualization system components (or its agents). In some cases, an agent of the virtualization system at each node can configure remote-memory mappings (or portions thereof) into its node-resident host operating system and/or into other node-resident host software, and/or into memory mapping hardware.

Due to any one or more of the foregoing memory mappings, in combination with any other memory mappings (e.g., as may be made via CPU-accessible memory maps such as translation lookaside buffers and/or in combination with any forms of memory, and/or various memory mappings as may be present in registration information and/or in any inter-node memory mappings), the CPU of HostA can be made oblivious to the fact that its memory accesses are actually satisfied by accessing physical memory in the address space of HostB. Furthermore, and in most cases, once configured, the host operating system of HostA is also oblivious to the fact that its memory accesses are actually satisfied by accessing physical memory in the address space of HostB. Still further, and in most cases, once configured, the VM of HostA is oblivious to the fact that its memory accesses might actually be satisfied by accessing physical memory that resides in the physical address space of HostB.

FIG. 1A2 also shows how a first fabric component (e.g., fabric 114₁) can be interfaced with a second fabric component (e.g., fabric 114₂). In this manner, by registering memory (e.g., via registration information 120_{A} and/or via registration information 120_{B}) with a fabric component, any additional fabric components can be populated with a corresponding instance of their own inter-node memory map (e.g., inter-node memory mappings 122₂). One example of this is shown by the depicted additional fabric component (e.g., additional routing components 117).

In certain topologies, and in particular, in topologies where a switch fabric is implemented between nodes, it can happen that the CPU of HostA is oblivious to the fact that an inter-node fabric is involved when a memory access is initiated by the CPU of HostA. This is because fabric components can be populated with a sufficiency of inter-node memory mappings such that memory access requests (e.g., any of READ or WRITE or instruction FETCH requests) are mapped to a final destination in a manner such that the initiator of a memory access request does not need to know the actual mapped-to address. Instead, the initiator of a memory access request merely raises the memory access as if it were a memory access to an address in its own virtual or physical address space. Given a sufficiency of inter-node memory mappings, an address of HostA in its own address space (e.g., within host address space 112_{A}) is translated and forwarded by a remote memory access device to a fabric component, which fabric component in turn maps and forwards the access request to another remote memory access device, which in turn maps the forwarded access request into an access request pertaining to the remote address space of the destination node (e.g., host address space 112_{B} of HostB).

As used herein, the term “instruction fetch” refers to an operation performed by a CPU to load opcode(s) and operands (if any) into a register of the CPU. Once the opcode(s) and operands (if any) have been loaded into a register of the CPU, the CPU will then decode the opcode so as to invoke hardware of the CPU to execute the opcode over the operands (if any). The location of the physical memory that contains the opcode(s) and operands (if any) can be in physical memory that is local to the CPU (e.g., situated in the same computing node) or, in accordance with embodiments of the disclosure, the location of the physical memory that contains the opcode(s) and operands (if any) can be in physical memory that situated in a computing component (e.g., in a different node or in a fabric component) that is remote from the CPU.

The configurations of FIG. 1A1 and FIG. 1A2 support a wide range of use models as pertains to migration and replication of virtual machines. Any one or more of such use models can be implemented through effective manipulation of memory mapping tables and/or effective configuration of remote memory access devices and/or corresponding fabric components. Several variations of page tables are shown and described as pertains to FIG. 1B.

FIG. 1B shows a flowchart depicting an example virtual machine migration technique that supports remote host direct memory accesses by a virtual machine during various migration phases. As an option, one or more variations of virtual machine migration technique 1B00 or any aspect thereof may be implemented in the context of the architecture and functionality of the embodiments described herein and/or in any environment.

The figure is being presented to illustrate how memory address space mappings can take place during the actual execution of a virtual machine. More specifically, the figure introduces how memory mapping tables and/or effective configuration of remote memory access devices and/or corresponding fabric components can take place during various phases of a virtual machine migration.

The steps and decisions of the shown virtual machine migration technique 1B00 can be implemented partially in hardware and partially in software. In some cases, the hardware can be configured via software and thereafter the hardware implements hardware-assisted memory mapping and memory accessing, including memory accesses from HostA that are actually satisfied by accesses to physical memory that exists on HostB. In some cases, the hardware-assisted memory mapping involves trapping on certain memory addresses such that logic implemented in a trap routine can facilitate accesses to a remote host having a remote memory access device, which remote memory access device is accessed over a remote memory access fabric manager.

Irrespective of whether a step or decision is implemented in hardware or in software or both, the logic of virtual machine migration technique 1B00 can comport with the description as follows: During execution of a VM at a local node, a virtual machine memory address access is considered (step 119). At decision 124 it is determined whether or not a migration is currently in progress. The determination can be made on the fly (e.g., on the basis of an address value), or the determination could have been made earlier and programmed into the memory mapping and/or remote memory access device hardware. In the specific case of when the determination had been made earlier, HostA can communicate with HostB using any known techniques to cause a memory map to be programmed into memory mapping tables and/or into remote memory access device hardware. As such, it is possible for various components of HostB (e.g., a virtualization system of HostB) to be aware that a virtual machine having a particular virtual memory configuration is the subject of a live migration. Moreover, it is possible for various components of HostB (e.g., the virtualization system of HostB) to be aware of precisely which memory pages of the virtual machine from HostA have corresponding copies that are resident in the physical memory devices at HostB.

Now, returning to decision 124, if it is determined that a migration is not currently in progress, then the “No” branch of decision 124 is taken and (at step 126) the virtual memory address is mapped to a physical memory address of the memory of the local host (e.g., using TLBs or other sets of virtual-to-physical address translations), and the local host memory is accessed (step 134). Alternatively, if it is determined that a migration is currently in progress, then the “Yes” branch of decision 124 is taken and (at step 128) the considered virtual memory address is at least potentially mapped to an address in a host-local remote memory access device's address space.

After taking the “Yes” branch of decision 124, and after performance of step 128, a further decision is undertaken, specifically, to determine (e.g., at decision 130) if the memory access is a WRITE operation or not. This determination can be made in hardware rather than in software.

If the memory access is determined to be a WRITE operation, then the “Yes” branch of decision 130 is taken and, at step 132, a region (e.g., a page) corresponding to a page within the CXL device address space is copied to a remote host (e.g., a destination host). As can be understood, once a page of memory has been copied (e.g., from a source node a target node) and mapped, further copies of that page are unnecessary. Rather, once a page of memory has been copied (e.g., from the source node to a target node) and mapped, further accesses by the virtual machine to any addresses within that virtual page can be satisfied by accessing physical memory in the physical address space of the target node.

The determination as to what page or pages within the remote memory access device address space is to be copied to the remote host can be made in hardware (e.g., using registers of the remote memory access devices). On the other hand, if the memory access is not a WRITE operation then, as shown, there are two different cases (e.g., Case1 and Case2) corresponding to two different “No” branches:
Case1 corresponds to the situation where the contents of the VM memory has not yet been copied to the remote host. This happens when the “Yes” branch of decision 130 had not yet been taken for the page corresponding to the accessed memory address.
Case2 corresponds to the situation where the contents of the VM memory have already been copied to the remote host. This happens when the “Yes” branch of decision 130 has been taken for the page corresponding to the accessed memory address. In this latter case, (e.g., case2) the memory contents of the memory at the remote host is accessed (step 136). In the former case (e.g., case1) since the memory contents of the VM has not yet been copied to the remote host, the memory at the local host is accessed (step 134).

As can be seen, as the VM executes and as data is copied from local memory to remote memory, it follows that, on an ongoing basis “dirty pages” end up in the physical memory at the remote host. In a separate, concurrently-running process, the other pages (e.g., the not dirty pages) can be copied to HostB. At some point in time, a decision can be made to enter a cutover phase during which phase the VM that had been running on HostA can be quiesced and then moved to HostB. The mapping tables at HostB can be configured to map VM virtual machine accesses of the VM on HostB to access memory at HostB, and the migration of the VM can be considered complete. In some cases, a VM has additional assets that can be copied over from HostA to HostB while the VM is quiesced. In such cases, the migration of the VM to HostB can be considered complete after the assets from HostA have been copied over from HostA to HostB. There are many variations to these VM migration use cases. Mechanisms for implementing these VM migration use cases using address mappings and hardware componentry are discussed further hereunder.

### Pre-Copy Case Using Extended Page Tables and Dirty Memory Tracking

Consider a case where virtualization system software configures hardware to facilitate the migration. More specifically, consider a multi-node cluster configuration where there exists a virtual machine VMA with its memory allocated on node HostA, and having addresses from address Ai to address Aj. Further consider that this virtual machine VMA was subjected to pre-copy migration preparations such that addresses from address Bi to address Bj have been reserved at node HostB to accommodate the incoming, to-be-migrated virtual machine VMA. In such a configuration, the virtualization software configures the extended page tables (if any) and/or other hardware (e.g., hardware that implements dirty memory tracking to track addresses that have been written to). Also, the virtualization system software (e.g., a hypervisor or controller virtual machine) can serve to program mapping hardware such that, when addresses Ai to Aj are read, the contents of the memory at those addresses Ai to Aj are not only read, but are also written to corresponding mapped-to addresses Bi to Bj. Iteratively, the virtualization software initializes/re-initializes (e.g., clears) the dirty memory tracking data structures such that, after some moment in time, only dirty pages are copied from addresses Ai to Aj to addresses Bi to Bj.

### Post-Copy Case Using PCIe Hardware Mapping

Consider a specific case where virtualization software configures PCIe hardware to map a local node's address range Bi . . . Bj to a remote node's address range Ai . . . Aj. This constitutes a “remote” memory access situation. In this post-copy regime, the virtualization software will initially move at least some of the VM's state to the remote node without initially moving all of its memory. Upon starting to execute instructions of the VM at the remote node, all or most memory accesses will actually be served by the source node where the majority of the memory resides. As such, the hypervisor can copy data from the source node to a remote node by managing inter-node memory mappings. In this manner, the entirety of the VM's memory can eventually be moved from the source node to the remote node, after which time the inter-node memory mappings can be severed.

Example of Initial Copying of Data from a Source Node to a Remote Node

When a running CPU at the remote node READs an address of the VM (e.g., an address in the range Ai . . . Aj), then, so as to accomplish initial population of VM data into memory at the remote node, the preconfigured hardware satisfies the CPU's READ by, firstly, moving the memory contents of a corresponding virtual machine address of the source node (i.e., an address in the range Bi . . . Bj) over a hardware link, then by, secondly, satisfying the CPU READ using the copied-over memory contents.

### Proactive Asynchronous Virtual Machine Memory Migration

In some situations, rather than waiting for a CPU of a target node to READ a virtual machine address for which the actual physical memory corresponding to the virtual machine address is in the source node, selected portions of the memory contents from the source node are moved proactively to the target node—independent of the processing of the CPU of the target node. Strictly as one implementation example, a migration agent (e.g., an inter-node migration agent) can be instructed to proactively move pages of memory from the source node to the target node. The selection of which pages of the source memory are moved first, or second, or third and so on can be made based on any prioritization criteria. For example, in the event that there exists a memory usage profile pertaining to previous executions of the virtual machine at the source node, the migration agent can use the information in the memory profile so as to first move memory pages that are deemed to be among the most frequently accessed pages. This can be particularly effective in applications where, even though a VM has allocated a very large amount of memory (e.g., for a database file), only a small portion of that large amount of memory is frequently accessed during the running of the virtual machine (e.g., in situations where a large database file is sparsely populated).

Further details regarding general approaches to moving selected portions of virtual machine data from a source node to a target node are described in U.S. Pat. No. 11,157,368 titled “USING SNAPSHOTS TO ESTABLISH OPERABLE PORTIONS OF COMPUTING ENTITIES ON SECONDARY SITES FOR USE ON THE SECONDARY SITES BEFORE THE COMPUTING ENTITY IS FULLY TRANSFERRED” issued on Oct. 26, 2021, which is hereby incorporated by reference in its entirety.

As can be seen from the foregoing use cases, various memory mapping techniques can be employed based on the then-current status of the virtual machine's memory. Examples of such memory mapping techniques are shown and described infra.

FIG. 1C depicts a source-side virtual machine memory mapping technique that supports remote host direct memory accesses by a virtual machine. As an option, one or more variations of source-side virtual machine memory mapping technique 1C00 or any aspect thereof may be implemented in the context of the architecture and functionality of the embodiments described herein and/or in any environment.

The figure is being presented to illustrate how memory can be mapped between two nodes that are interconnected over remote memory access devices so as to facilitate a live migration 123 of a virtual machine.

As is understood by those skilled in the art, a VM's virtual memory address can be mapped to a physical memory address of its host. As depicted in the figure, a VM's virtual memory address can be mapped to a physical memory address. This can be accomplished using multiple mappings. For example, a VM's virtual memory address can correspond to a guest OS memory address at a source host. In this case, the guest OS memory address is in turn mapped to a host OS memory address which is in the range of the address space of the source host. As shown, some of the address space of the source host is mapped to RAM, and some of the address space of the source host is mapped to the memory-mapped address space of a remote memory access device, which in turn is mapped to some memory location of the target host.

When a memory address corresponding the memory-mapped address space of a remote memory access device (e.g., the shown instance of host-local fabric interface device 121_{A}) is accessed, a mapped-to remote physical address is calculated (e.g., via a lookup of inter-node memory mappings 122) and the memory-mapped address space of a different remote memory access device (e.g., the shown instance of host-local fabric interface device 121_{B}) is accessed over hardware components that comprise the remote memory access fabric.

The foregoing page tables and other hardware components can be initialized and/or manipulated such that migration of a virtual machine from HostA to HostB (e.g., movement of pages of the virtual address space M1_{S} of the VM from HostA to a virtual address space M1_{T} of HostB) can take place during the course of execution of the VM on HostA. Strictly as one example of hardware components that can be initialized and/or manipulated for VM migration, the shown instance of host-local fabric interface device 121_{A} can be CXL-compliant infrastructure (e.g., a CXL device) that facilitates CPU-oblivious access to a mapped-to remote physical address through the host-local fabric interface device 121_{B}, which host-local fabric interface device 121_{B} can also be CXL-compliant infrastructure.

As can be understood by those skilled in the art, it can be an implementation choice as to when to cut over actual execution of the VM from HostA to HostB. In one case, such as is discussed in the foregoing example of FIG. 1C, the memory and assets of a VM can be copied over to a remote host before execution of the VM begins at the remote host. As a first alternative, execution of the VM can be cut over to the remote host before its memory is moved from the local host to the remote host. As a second alternative, execution of the VM can be cut over to the remote host at any point in time—even when just some portion of its memory has been moved from the local host to the remote host. Representative cases are shown and described as pertains to the alternative virtual machine migration techniques of FIG. 1D.

FIG. 1D depicts alternative virtual machine migration techniques that support remote node direct memory accesses by a virtual machine running on a local node. As an option, one or more variations of alternative virtual machine migration techniques 1D00 or any aspect thereof may be implemented in the context of the architecture and functionality of the embodiments described herein and/or in any environment.

The top portion of FIG. 1D corresponds to a technique sometimes known as “pre-copy”. In the pre-copy regime, all or at least some of the assets (e.g., executable instructions, in-memory data, virtual machines, configuration data, etc.) are moved from a local host to a remote host before execution of the VM commences at the remote host. More specifically, a series of CXL operations 146₁ are carried out during execution of step 142. As shown, such CXL operations 146₁ are under control of step 142, which iterates in a loop (e.g., the shown loop1) until, at decision 144₁, a determination is made that all of the memory contents of the source VM has been moved to the physical memory of the target. As such, when the “Yes” branch of decision 144₁ is taken (i.e., all of the memory contents of the source VM has been moved to the physical memory of the target), then step 148 serves to initiate a cutover of execution from the VM of the source to the VM at the target. Once the cutover of execution of the VM at the target has concluded, then resources that had been allocated to the VM at the source can be reclaimed (step 1501).

The bottom portion of FIG. 1D corresponds to a technique commonly known as “post-copy”. In the post-copy regime, execution of the VM commences at the remote host before all or at least some of the assets (e.g., executable instructions, in-memory data, virtual machines, configuration data, etc.) are moved from a local host to a remote host.

More specifically, and as shown, a VM is moved from a source to a target (step 152) and a cutover is initiated. This means that the VM that had been moved from the source node to the target node is now executing at least some instructions that are actually stored in physical memory of the target node. After the cutover is at least initiated, a series of CXL operations 146₂ are carried out during execution of step 154. As shown, such CXL operations 146₂ are under control of step 154, which iterates in a loop (e.g., the shown loop2) until, at decision 144₂, a determination is made that all of the memory contents of the source VM has been moved to the physical memory of the target. As such, when the “Yes” branch of decision 144₂ is taken (i.e., all of the memory contents of the source VM has been moved to the physical memory of the target), then resources that had been allocated to the VM at the source can be reclaimed (step 150₂).

FIG. 1E depicts a target-side virtual machine memory mapping technique that supports remote host direct memory accesses by a virtual machine. As an option, one or more variations of depicts a target-side virtual machine memory mapping technique 1E00 or any aspect thereof may be implemented in the context of the architecture and functionality of the embodiments described herein and/or in any environment.

This particular example is being presented to illustrate how such a VM that is the subject of live migration 123 can be situated at a target node, and immediately upon such situation, the VM can execute on the target node based on the contents of memory, all or portions of which reside on the source node. In this example, virtual machine 102_{DORMANT} on the source node is the subject of the live migration. The memory mapping on the source node includes mapping of a first portion of the address space of the VM to RAM as well as a mapping of a second portion of the address space of the VM to a remote memory access device. Such execution of a VM on the target node based on the contents of memory that reside on the source node can be carried out continually. That is, once a VM on the target node is able to execute an instruction based on the contents of memory that reside on the source node, then a next instruction can be executed, and the next instruction after that, and so on.

To prepare for a cutover that causes execution of the VM at the target node rather than the VM of the source node, various memory mapping information (e.g., registration information 120_{A} and registration information 120_{B}) is exchanged between the source node and the target node. After such memory mapping information has been exchanged between the two nodes, the target node is able to begin execution of the to-be-migrated VM at the target node using the CPU of the target node. Also, execution of the to-be-migrated VM at the source node can cease. In some embodiments, the to-be-migrated VM at the source node can be put into a quiescent state and, upon achievement of such a quiescent state, the VM code as well as other VM configuration data can be delivered to the target node. The cutover can be accomplished by initiating execution of the to-be-migrated VM at the target node using the CPU of the target node. Since the VM had been quiesced as of the moment when execution of the to-be-migrated VM is initiated at the target node, the memory of the to-be-migrated VM that is at the source node is in exactly the same state as it was at the time of the quiescence. When virtual machine 102_{ACTIVE} begins to execute, the virtual machine 102_{DORMANT} at the source node can remain in a quiescent or halted sate. Thereafter, as virtual machine 102_{ACTIVE} executes by accessing memory pages from the source node, those pages and other pages can be copied over to the target node. When a page is copied from the source node to the target node, the mappings can be updated such that a further access by virtual machine 102_{ACTIVE} to that page would be satisfied by accessing physical memory of the target node.

Ongoing execution of the virtual machine 102_{ACTIVE} might access all pages that comprise its virtual memory space, thus causing all pages to be copied to the target node during execution. However, various steps can be taken to ensure that all pages be copied to the target node regardless of whether or not execution of the virtual machine 102_{ACTIVE} accesses all pages. A background task can execute to be certain that, at least at some point, a copy of all pages from the source node have indeed been copied over to the target node.

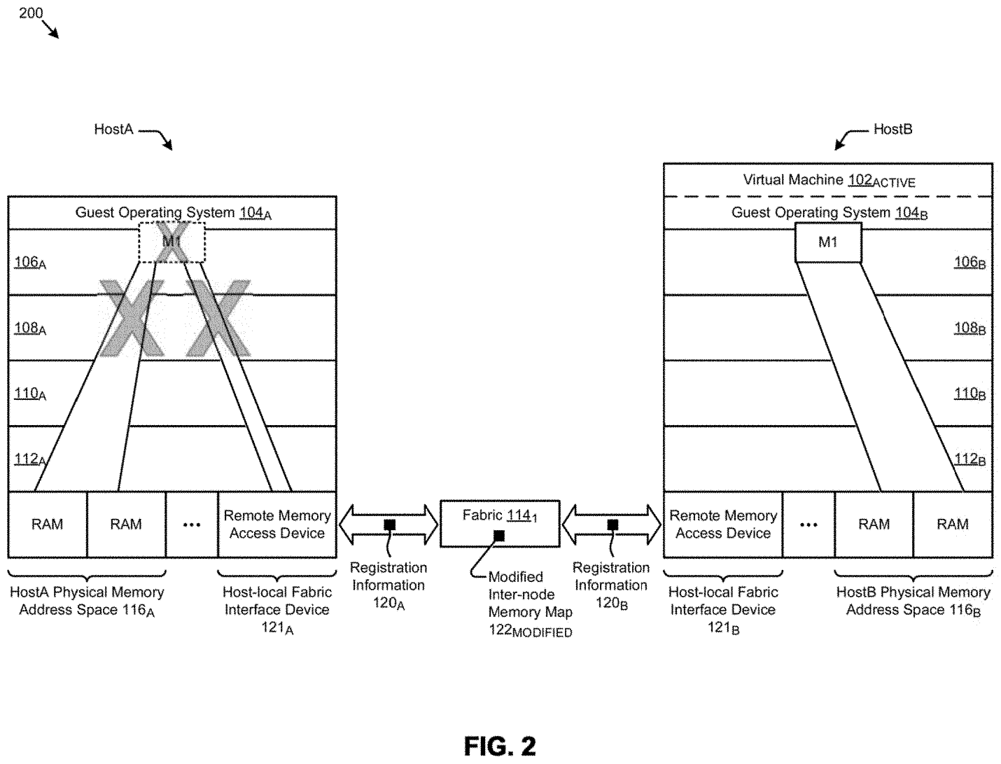

When all pages from the source node have indeed been copied over to the target node, the memory that formerly comprised the virtual memory of the source node's virtual machine 102_{DORMANT} can be reclaimed. One possible technique for source-side virtual machine memory reclaiming is shown and described as pertains to FIG. 2.

FIG. 2 depicts a source-side virtual machine memory reclaiming technique. As an option, one or more variations of depicts a source-side virtual machine memory reclaiming technique 200 or any aspect thereof may be implemented in the context of the architecture and functionality of the embodiments described herein and/or in any environment.

The figure depicts the situation at a point in time after a VM's memory image has been moved from a source node to a target node (e.g., from HostA to HostB). At that point in time, the full address space of the VM (e.g., virtual machine) at the target node is memory mapped to physical memory at the target node. When all of the memory contents that were formerly situated at the source node have been copied to the target node, there is no longer a need to retain the memory contents at the source node. As such, the source-side virtual machine memory reclaiming technique 200 can perform cleanup (1) by releasing any physical memory that had been allocated to the VM that is now at the target node (shown as a “Xs” in FIG. 2), and (2) by releasing or otherwise cleaning up any mappings that had been in place during the migration (e.g., by modifying any inter-node memory mappings to generate modified inter-node memory mappings 122_{MODIFIED}).

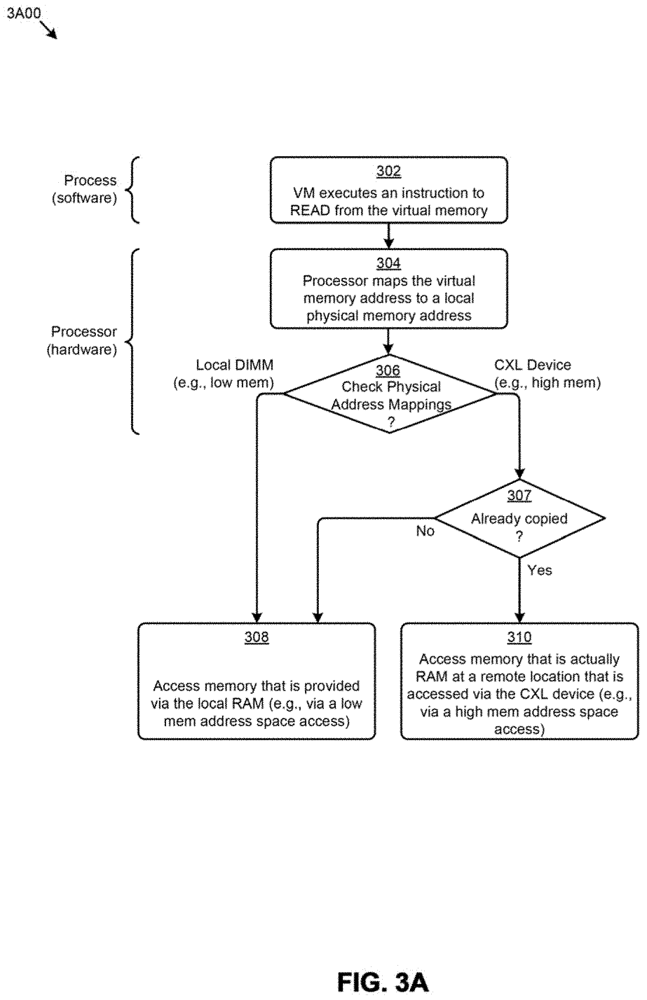

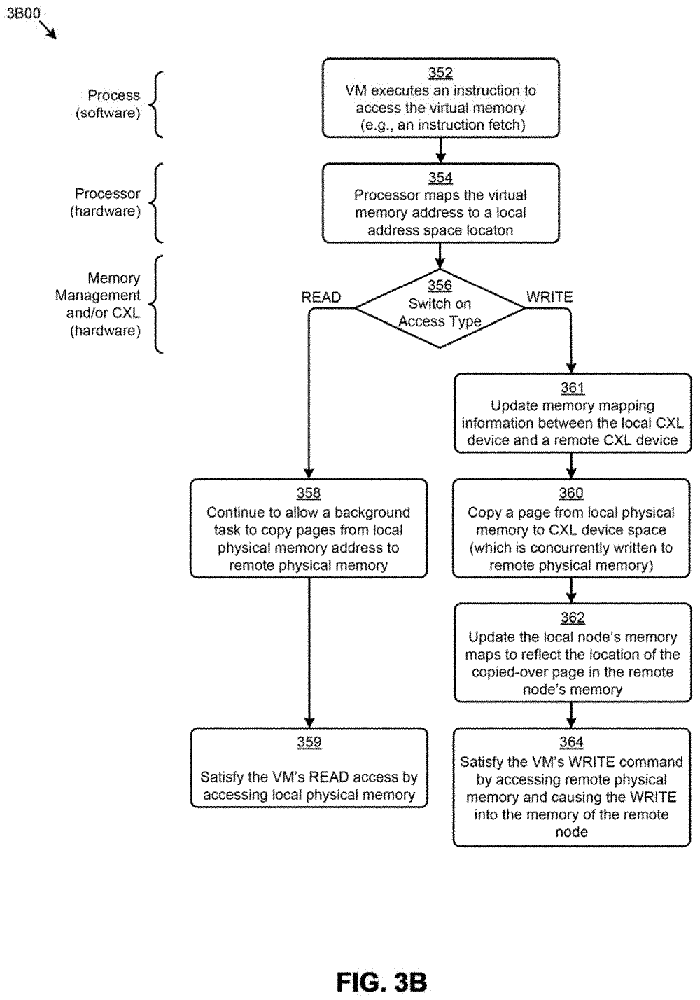

As previously discussed, one live migration approach known as “pre-copy live migration” relies on detecting when a page of memory is modified by a virtual machine running on a source node, and then copying the changed page to the target node. This often involves repeatedly copying the changed page to the target node. In some situations, ongoing changes to a page at the source node happen so frequently that it is never possible to have the same page contents at both the source node and the target node. When such a situation is detected, the virtual machine at the source node must be quiesced. The need to quiesce a VM is strongly unwanted. A better way is shown and discussed as pertains to FIG. 3A.

FIG. 3A depicts a hardware-assisted remote host direct memory access technique that supports mapping from a local host virtual machine memory address to a remote host virtual machine memory address. As an option, one or more variations of hardware-assisted remote host direct memory access technique 3A00 or any aspect thereof may be implemented in the context of the architecture and functionality of the embodiments described herein and/or in any environment.

As heretofore discussed, specifically as pertains to the foregoing virtual machine migration techniques, the determination as to whether to access a particular virtual machine's virtual memory address from local host memory or from remote host memory can be made using translation lookaside buffer hardware (e.g., to accomplish page table lookups) and/or using other hardware components (e.g., to accomplish mapping and retrieval). In exemplary cases, a combination of hardware of a CPU processor together with memory management hardware, TLBs, and/or CXL hardware serve to carry out remote memory accesses over the CXL fabric. When using such memory management hardware and/or CXL hardware, a remote memory access can be accomplished while incurring latency of only a handful of memory cycles. This means that a workload of a virtual machine of a local node, and/or of a human operator who is using the virtual machine, may not even notice that actual memory contents from physical memory of a remote node are being fetched in response to execution of an instruction of the virtual machine situated at the local node. Of course, when an address is not mapped (e.g., via the CXL hardware) to an address in physical memory of a remote node, then the memory access is satisfied using the physical memory of the local node.

As shown, when a VM executes an instruction to READ from its virtual memory (step 302), the CPU or other processor maps the virtual memory address to a host-local physical address (step 304). At decision 306, the host-local physical address as determined by step 304 is checked against a host-local physical memory map. If the host-local physical address as determined by step 304 refers to RAM address, the left branch of decision 306 is taken and the READ is satisfied by accessing local memory (step 308). Otherwise, if the host-local physical address corresponds to a CXL device, then the right branch of decision 306 is taken.

As can be seen from the foregoing, RAM that is referenced by a CXL device can be RAM that is in the address space of a remote host, or RAM that is referenced by a CXL device can be RAM that is in the address space of the same (local) host. It is also possible that one range of addresses that map to a CXL device refers to RAM that is in the address space of a remote host, whereas a second range of addresses that map to the same CXL device refers to RAM that is in the address space of a remote host.

At decision 307, a determination is made as to whether or not the page corresponding to the READ has already been copied to the target node. If so, the “Yes” branch of decision 307 is taken and the memory address is made over the CXL device (step 310). Otherwise, the “No” branch of decision 307 is taken and the READ is satisfied by accessing local memory (step 308).

The determination as to whether or not the page corresponding to the READ has already been copied to the target node can be made using hardware and/or software, either singly or in combination. Moreover, there can be any number of agents that perform copying (e.g., in the background) of pages of memory from local RAM to remote RAM. When the contents of a page have been copied from local RAM to remote RAM, the responsible agent can mark that page as having been copied to the remote RAM.

FIG. 3B shows a flowchart depicting a hardware-assisted page copy technique. As an option, one or more variations of hardware-assisted page copy technique 3B00 or any aspect thereof may be implemented in the context of the architecture and functionality of the embodiments described herein and/or in any environment.

The figure is being presented to show how a processor, in conjunction with memory management hardware, TLBs, and/or CXL hardware can be used to implement high-performance virtual machine migration. Specifically, FIG. 3B is being presented to show how a processor, in conjunction with memory management hardware, TLBs, and/or CXL hardware can be used to implement immediate word or page copies and memory remapping during virtual machine migration.

The shown flow observes two principles:
Principle #1: Perform an immediate copy of a word or page of memory (from a source host to a target host) whenever a WRITE memory operation is encountered (step 360).
Principle #2: As a background task (e.g., at step 358), while the VM is executing on this source host, perform a copy of any pages that have not yet been the subject of an immediate copy, such as described by Principle #1.

As an outcome of observing both Principle #1 and Principle #2 over time, there comes a moment when all of the pages of the virtual machine's physical memory at the target node are identical to all of the corresponding pages of the memory at the source node. At such a time (e.g., at a cutover time), execution of the VM on the source node can cease—in favor of execution of the VM at the target node. In some cases, such as when all of the memory contents of all of the pages of the virtual machine's physical memory at the target node are identical to all of the memory contents of the corresponding pages of the memory at the source node, a cutover can be initiated. At or after that moment in time when the cutover completes, the live migration can be deemed complete.

The foregoing Principle #1 operates as follows: When a virtual machine executes an instruction to access virtual memory (step 352), the CPU processor and/or its co-processors maps the virtual address to a local address space address (step 354). If the aforementioned access to virtual memory is a READ memory command, then decision 356 will take the “READ” branch and, at step 358, a background task copies memory pages from the local node to memory pages of the remote node. The READ memory command is satisfied (step 359) by accessing local physical memory of the source node.

On the other hand, if the aforementioned access to virtual memory is a WRITE memory command, then decision 356 will take the “WRITE” branch and, at step 361, configurations of the CXL devices (e.g., configurations of any CXL devices at the local node, any configurations of CXL devices at the remote node, and/or configurations of any fabric devices) are updated to (1) map the written-to page to CXL device memory of the local node, and to (2) map the corresponding page of the remote memory such that, at step 360, an immediate copy of the to-be-written-to word or page of local memory is stored into the corresponding word or page of remote memory.

When the immediate copy has been at least initiated, the CPU processor's memory maps (e.g., TLBs) can be updated (step 362) such that any future WRITEs to any address in the page that has just been copied to the remote node can be satisfied via actual direct access to physical memory of the remote node. The WRITE command is then performed (step 364) by accessing remote physical memory (e.g., over interconnect fabric components) in a manner that causes the WRITE to occur into the memory of the remote node.

The foregoing techniques include copying (e.g., as a background task) of any pages that have not yet been the subject of an immediate copy (such as described by Principle #1). Such a background task can be accomplished using a combination of software instructions (e.g., in a thread) in conjunction with hardware acceleration (e.g., using CXL hardware) whereby the software keeps track of pages to copy and initiates such a copy.

As can now be observed, when all of the contents of all of the pages of both the VM at the source node and all of the contents of all of the pages of the VM at the target node have become identical, then that state can be maintained on a continuing basis such that the VM at the target node can serve continually as a hot backup. Execution can be switched over to the VM at the target node within the timeframe of just a few memory cycles.

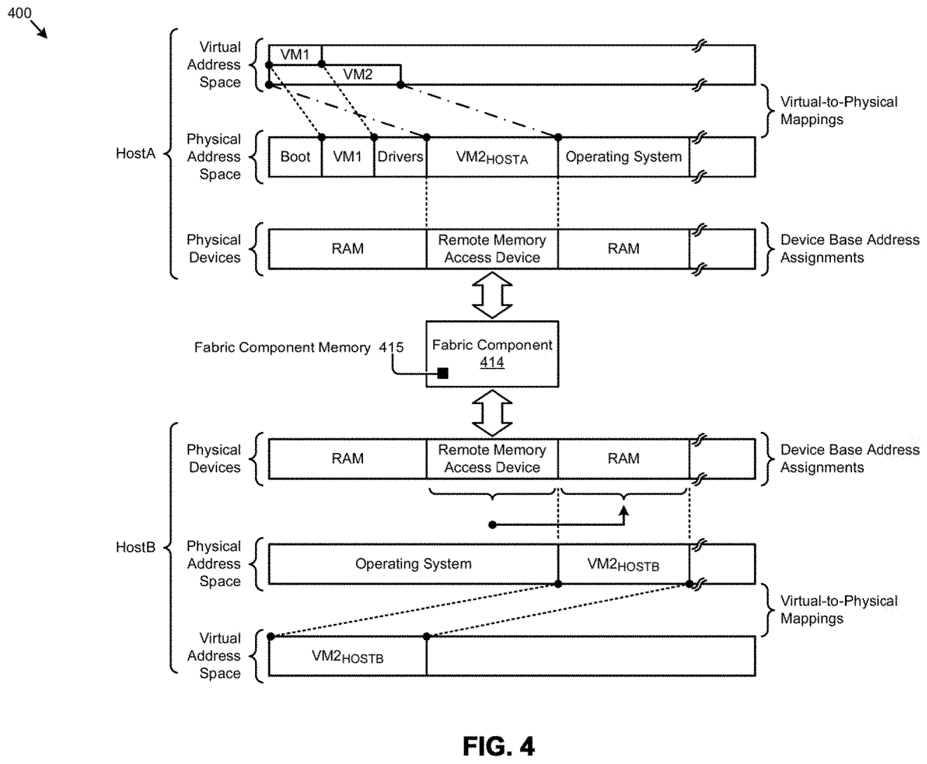

In hardware-assisted embodiments involving CXL devices, software can merely configure the CXL hardware such that the CXL hardware itself (e.g., CXL fabric components) keeps track of virtual machine memory pages to copy, and autonomously initiates copying of virtual machine memory pages via repeated memory page copies. A technique for such autonomous mirroring of virtual machine memory pages to a remote host is shown and described as pertains to FIG. 4.

FIG. 4 depicts cross-host virtual machine memory mappings 400. The figure is being presented to illustrate how a series of mappings enable a memory access command of a first virtual machine of a first virtualization system running on a first computing node (e.g., HostA) to be carried out by accessing a corresponding second memory location of a second virtual machine of a second virtualization system running on a second computing node (e.g., HostB). Furthermore, the figure is being presented to illustrate the scenario where the set of virtual machines on HostA are different from the set of virtual machine of HostB.

As shown, HostA hosts two virtual machines, specifically virtual machine VM1 and virtual machine VM2, both of which have virtual address spaces from address zero to some higher address for virtual machine VM1 and to a still higher address for virtual machine VM2. A series of virtual-to-physical mappings are maintained by computing infrastructure at HostA such that, at any moment in time, an access to a virtual machine address within a virtual address space can be mapped to a corresponding physical address. Furthermore, and as shown, the physical address space of HostA is divided into several regions, some or all of which have different purposes, and some or all of which are mapped to different devices (e.g., RAM or a remote memory access device). In the depiction of HostA, the portion of the physical address space that is dedicated to a particular virtual machine (e.g., VM_{HOSTA}) is mapped to a remote memory access device.

In accordance with this mapping, and strictly as an example, when a CPU of HostA initiates an instruction fetch operation (e.g., to fetch a next instruction of virtual machine VM2), the following takes place: (1) a first set of mappings converts the virtual address to a physical address, and (2) the device at the mapped-to physical address is accessed. Meanwhile the CPU is awaiting completion of the instruction fetch operation. The physical address space of virtual machine VM2_{HOSTA} corresponds to a remote memory access device and, as such, the instruction fetch operation is actually carried out using the facilities of the interconnection fabric. In this example, fabric 114₂ is employed to cause the fetch operation of the CPU of HostA to be carried out by computing infrastructure of HostB. To illustrate, the instruction fetch by the CPU of HostA is received by the remote memory device of HostB, upon which receipt the remote memory device of HostB accesses its respective memory registrations so as to actually access physical memory (e.g., RAM) of HostB. As shown, the physical RAM memory of HostB corresponds to a memory mapping that arises from virtual-to-physical mapping of virtual machine VM2_{HOSTB}.

In some embodiments, one or more fabric components may host physical memory, which in turn may include virtual machine instructions and data. As previously indicated, interconnection fabric components comprise specialized hardware that permits a first system (e.g., HostA) to access data and/or instructions from the memory of a second system (e.g., HostB). In some cases, the second system is a fabric component (e.g., fabric component 414) that hosts remote physical memory (e.g., fabric component memory 415), which remote physical memory can be accessed by any operational element of either the first system or the second system using any configuration of, and/or route through, the interconnection fabric.

The presence of remote physical memory in the hardware components that comprise the interconnection fabric facilitates a wide range of virtual machine migration scenarios. Strictly as an example, consider that a first CPU of a first node might process a first memory command of a first virtual machine running on a first computing node. When the first memory command is issued by the first CPU to perform a READ or a WRITE or an instruction FETCH of a first memory location of the first computing node, then rather than accessing the first memory location of the first computing node, instead, accessing a corresponding second memory location of remote physical memory of a fabric component to perform the READ or the WRITE or the instruction FETCH issued by the first CPU.

Now, referring to some of the heretofore disclosed embodiments, remote physical memory of a fabric component can be accessed by a CPU of a source node, and/or by a CPU of a target node. As such, it is completely flexible as to which portion or portions of a virtual machine's memory is available at the source node, or at the target node, or at a fabric component. More specifically, it may be convenient to store at least some portions of a virtual machine's memory in a fabric component, and then to choose the timing of when to cut over to a standby or dormant virtual machine of the target node. As such, in accomplishing the cutover, a standby or dormant virtual machine of the virtualization system running on a second computing node may be activated such that when the second computing node's CPU issues a memory command to perform a READ or WRITE or instruction FETCH of a second memory location of the second computing node, then, rather than accessing memory of the second computing node, instead mappings are applied to as to access corresponding remote memory of an interconnection fabric component to perform the READ or the WRITE or the instruction FETCH issued by the second computing node's CPU.

Any of the foregoing mappings can be initialized and/or modified using a variety of hardware and/or software components. Strictly for illustration, Table 1 depicts use of one or more agents (e.g., comprising hardware and/or software components) hosted on or implemented in a computing node.

TABLE 1
Example mapping agents

| | | Hardware Component(s) |
|---|---|---|
| Type of Mapping | Software Component(s) Involved | Involved |
| Virtual-to-Physical | Any one or more of a guest operating system, host | Memory management |
| Mappings (and reverse | operating system, a controller virtual machine (CVM) a | hardware (e.g., TLBs) |
| Physical-to-Logical | controller container, a virtual function I/O, a memory | |
| Mappings) | server, a migration agent as an ancillary control | |
| | process to a CVM, an operating system daemon, a | |
| | machine emulator (e.g., QEMU) extension, etc. | |
| Physical-to-Device | Boot routines, virtualization system initialization | Boot block non-volatile |
| Mappings | routines, CVMs, etc. | storage |
| Local Physical | Inter-node memory mapping system calls (e.g., device | Remote memory access |
| Addresses to Remote | driver calls), fabric component firmware, etc. | device internal mapping |
| Physical Address | | registers |

Any of the shown example software components can correlate to any of the shown example hardware components. Moreover, any combination of software components and hardware components can cause, whether employed singly or in combination, hardware and/or software memory map initializations and/or hardware and/or software memory map modifications and/or hardware and/or software memory map registrations.

### System Architecture Overview

### Additional System Architecture Examples

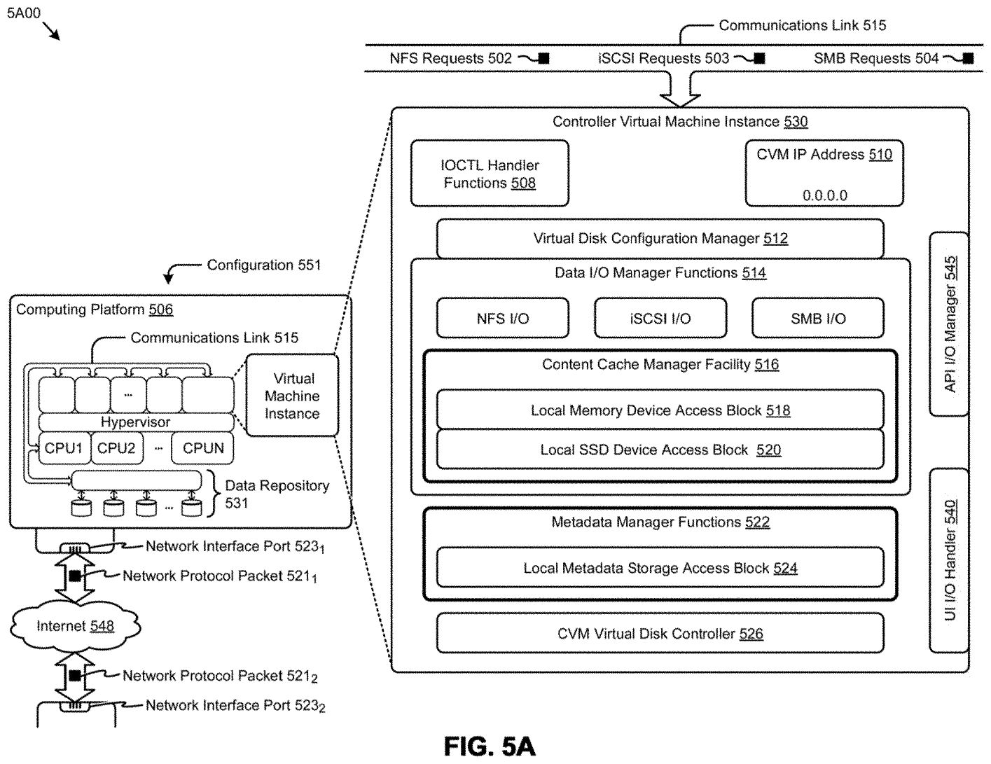

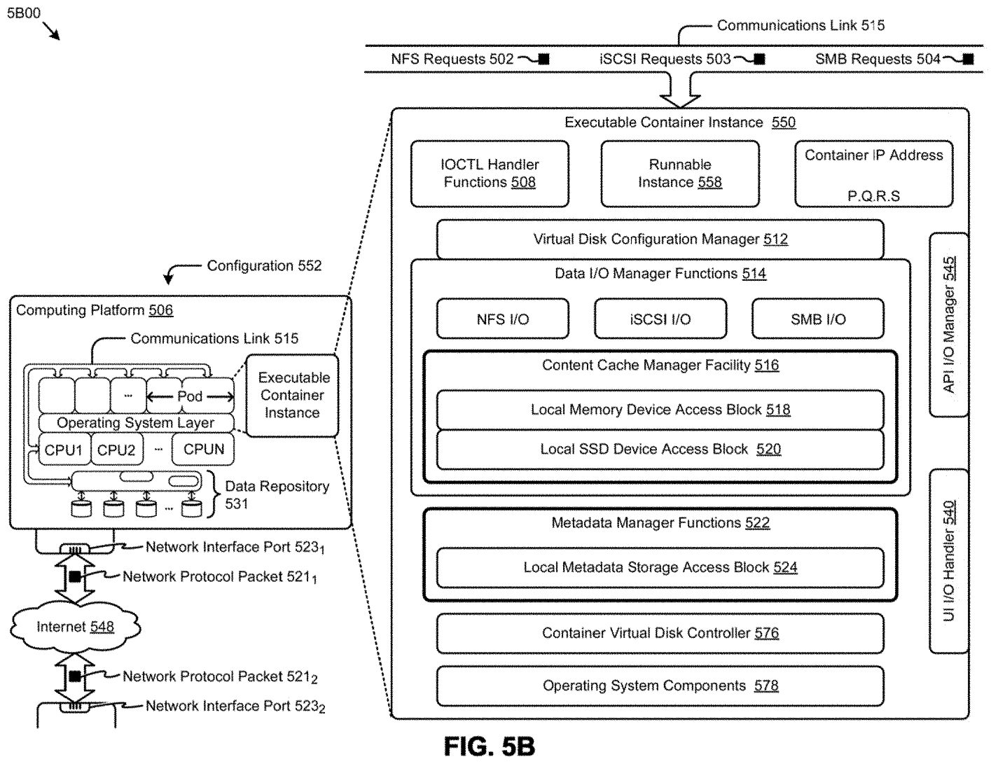

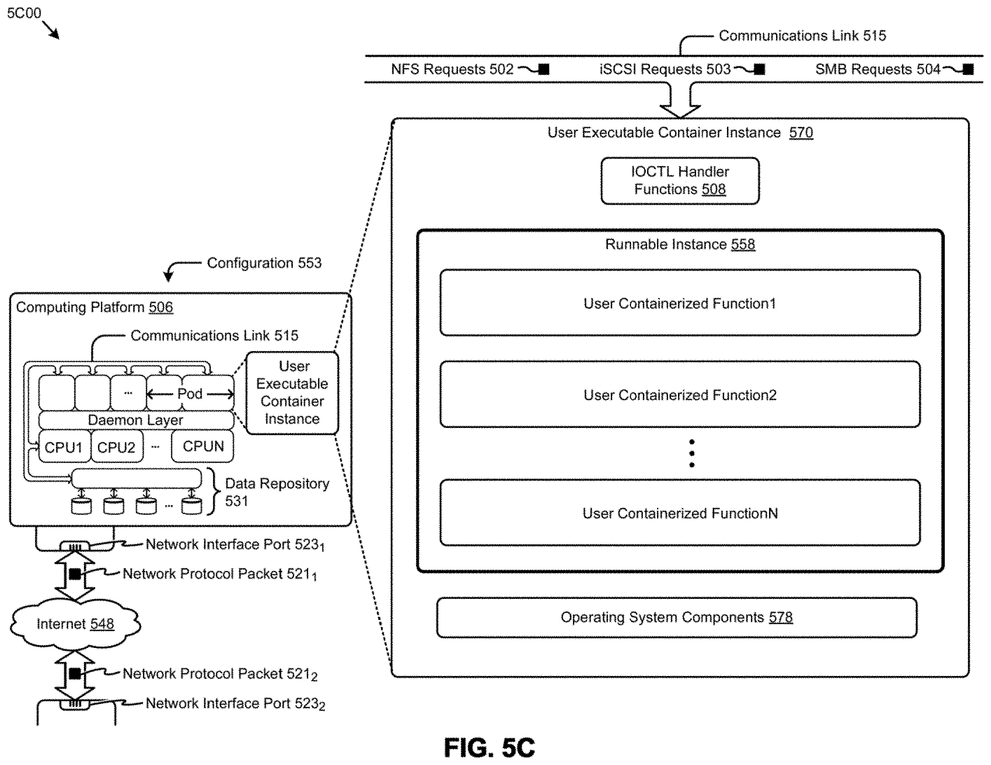

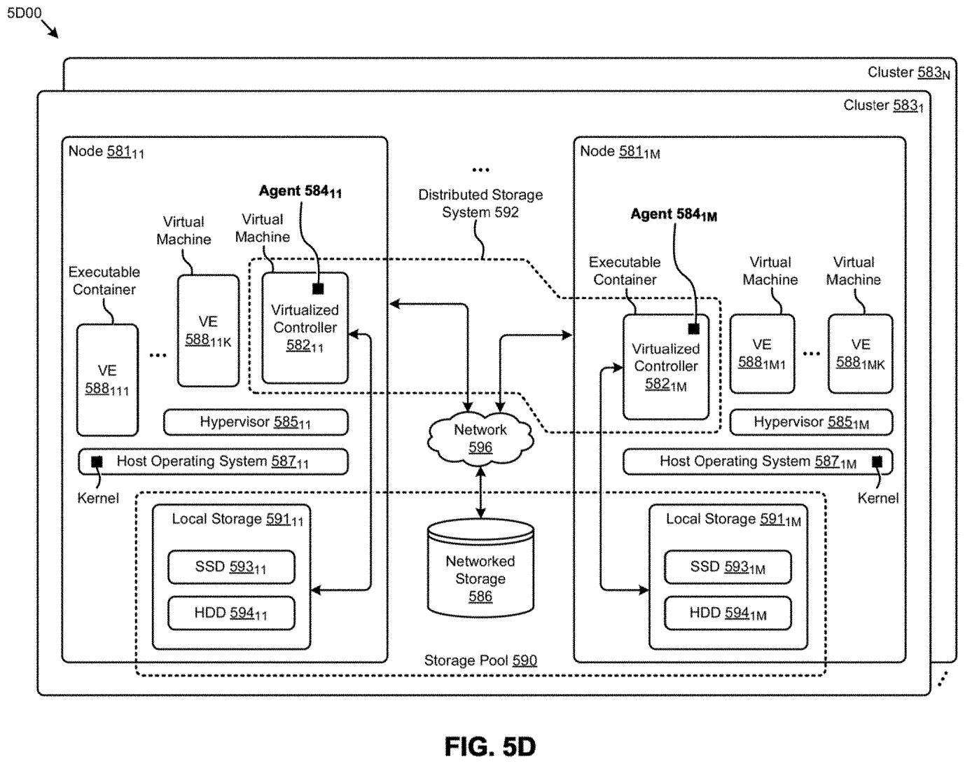

All or portions of any of the foregoing techniques can be partitioned into one or more modules and instanced within, or as, or in conjunction with, a virtualized controller in a virtual computing environment. Some example instances within various virtual computing environments are shown and discussed as pertains to FIG. 5A, FIG. 5B, FIG. 5C, and FIG. 5D.

FIG. 5A depicts a virtualized controller as implemented in the shown virtual machine architecture 5A00. The heretofore-disclosed embodiments, including variations of any virtualized controllers, can be implemented in distributed systems where a plurality of networked-connected devices communicate and coordinate actions using inter-component messaging.

As used in these embodiments, a virtualized controller is a collection of software instructions that serve to abstract details of underlying hardware or software components from one or more higher-level processing entities. A virtualized controller can be implemented as a virtual machine, as an executable container, or within a layer (e.g., such as a layer in a hypervisor). Furthermore, as used in these embodiments, distributed systems are collections of interconnected components that are designed for, or dedicated to, storage operations as well as being designed for, or dedicated to, computing and/or networking operations.

Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 5A00 comprises a collection of interconnected components suitable for implementing embodiments of the present disclosure and/or for use in the herein-described environments. Moreover, virtual machine architecture 5A00 includes a virtual machine instance in configuration 551 that is further described as pertaining to controller virtual machine instance 530. Configuration 551 supports virtual machine instances that are deployed as user virtual machines, or controller virtual machines or both. Such virtual machines interface with a hypervisor (as shown). Some virtual machines include processing of storage I/O (input/output or IO) as received from any or every source within the computing platform. An example implementation of such a virtual machine that processes storage I/O is depicted as 530.

In this and other configurations, a controller virtual machine instance receives block I/O storage requests as network file system (NFS) requests in the form of NFS requests 502, and/or internet small computer storage interface (iSCSI) block IO requests in the form of iSCSI requests 503, and/or Samba file system (SMB) requests in the form of SMB requests 504. The controller virtual machine (CVM) instance publishes and responds to an internet protocol (IP) address (e.g., CVM IP address 510). Various forms of input and output can be handled by one or more IO control handler functions (e.g., IOCTL handler functions 508) that interface to other functions such as data IO manager functions 514 and/or metadata manager functions 522. As shown, the data IO manager functions can include communication with virtual disk configuration manager 512 and/or can include direct or indirect communication with any of various block IO functions (e.g., NFS JO, iSCSI IO, SMB JO, etc.).

In addition to block IO functions, configuration 551 supports IO of any form (e.g., block JO, streaming JO, packet-based JO, HTTP traffic, etc.) through either or both of a user interface (UI) handler such as UI IO handler 540 and/or through any of a range of application programming interfaces (APIs), possibly through API IO manager 545.

Communications link 515 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, controller virtual machine instance 530 includes content cache manager facility 516 that accesses storage locations, possibly including local dynamic random access memory (DRAM) (e.g., through local memory device access block 518) and/or possibly including accesses to local solid state storage (e.g., through local SSD device access block 520).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 531, which in turn can be formatted into any one or more storage areas, and which can comprise parameterized storage accessible by a key (e.g., a filename, a table name, a block address, an offset address, etc.). Data repository 531 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 524. The data repository 531 can be configured using CVM virtual disk controller 526, which can in turn manage any number or any configuration of virtual disks.

Execution of a sequence of instructions to practice certain embodiments of the disclosure are performed by one or more instances of a software instruction processor, or a processing element such as a data processor, or such as a central processing unit (e.g., CPU1, CPU2, . . . , CPUN). According to certain embodiments of the disclosure, two or more instances of configuration 551 can be coupled by communications link 515 (e.g., backplane, LAN, PSTN, wired or wireless network, etc.) and each instance may perform respective portions of sequences of instructions as may be required to practice embodiments of the disclosure.

The shown computing platform 506 is interconnected to the Internet 548 through one or more network interface ports (e.g., network interface port 523₁ and network interface port 523₂). Configuration 551 can be addressed through one or more network interface ports using an IP address. Any operational element within computing platform 506 can perform sending and receiving operations using any of a range of network protocols, possibly including network protocols that send and receive packets (e.g., network protocol packet 521₁ and network protocol packet 521₂).

Computing platform 506 may transmit and receive messages that can be composed of configuration data and/or any other forms of data and/or instructions organized into a data structure (e.g., communications packets). In some cases, the data structure includes program instructions (e.g., application code) communicated through the Internet 548 and/or through any one or more instances of communications link 515. Received program instructions may be processed and/or executed by a CPU as it is received and/or program instructions may be stored in any volatile or non-volatile storage for later execution. Program instructions can be transmitted via an upload (e.g., an upload from an access device over the Internet 548 to computing platform 506). Further, program instructions and/or the results of executing program instructions can be delivered to a particular user via a download (e.g., a download from computing platform 506 over the Internet 548 to an access device).

Configuration 551 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to virtual machine remote host memory accesses. In some embodiments, a module may include one or more state machines and/or combinational logic used to implement or facilitate the operational and/or performance characteristics pertaining to virtual machine remote host memory accesses.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of virtual machine remote host memory accesses). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to virtual machine remote host memory accesses, and/or for improving the way data is manipulated when performing computerized operations pertaining to accessing a virtual machine instruction via an actual direct access to memory of a remote node that holds the instruction to be fetched.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT” issued on Oct. 1, 2013, which is hereby incorporated by reference in its entirety.

FIG. 5B depicts a virtualized controller implemented by containerized architecture 5B00. The containerized architecture comprises a collection of interconnected components suitable for implementing embodiments of the present disclosure and/or for use in the herein-described environments. Moreover, the shown containerized architecture 5B00 includes an executable container instance in configuration 552 that is further described as pertaining to executable container instance 550. Configuration 552 includes an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification (e.g., “http:”) and possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

The operating system layer can perform port forwarding to any executable container (e.g., executable container instance 550). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “ls”, “dir”, etc.). The executable container might optionally include operating system components 578, however such a separate set of operating system components need not be provided. As an alternative, an executable container can include runnable instance 558, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 576. Such a container virtual disk controller can perform any of the functions that the aforementioned CVM virtual disk controller 526 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 5C depicts a virtualized controller implemented by a daemon-assisted containerized architecture 5C00. The containerized architecture comprises a collection of interconnected components suitable for implementing embodiments of the present disclosure and/or for use in the herein-described environments. Moreover, the shown daemon-assisted containerized architecture includes a user executable container instance in configuration 553 that is further described as pertaining to user executable container instance 570. Configuration 553 includes a daemon layer (as shown) that performs certain functions of an operating system.

User executable container instance 570 comprises any number of user containerized functions (e.g., user containerized function1, user containerized function2, . . . , user containerized functionN). Such user containerized functions can execute autonomously or can be interfaced with or wrapped in a runnable object to create a runnable instance (e.g., runnable instance 558). In some cases, the shown operating system components 578 comprise portions of an operating system, which portions are interfaced with or included in the runnable instance and/or any user containerized functions. In this embodiment of a daemon-assisted containerized architecture, the computing platform 506 might or might not host operating system components other than operating system components 578. More specifically, the shown daemon might or might not host operating system components other than operating system components 578 of user executable container instance 570.

The virtual machine architecture 5A00 of FIG. 5A and/or the containerized architecture 5B00 of FIG. 5B and/or the daemon-assisted containerized architecture 5C00 of FIG. 5C can be used in any combination to implement a distributed platform that contains multiple servers and/or nodes that manage multiple tiers of storage where the tiers of storage might be formed using the shown data repository 531 and/or any forms of network accessible storage. As such, the multiple tiers of storage may include storage that is accessible over communications link 515. Such network accessible storage may include cloud storage or networked storage (e.g., a SAN or storage area network). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor (e.g., as shown in configuration 551 of FIG. 5A) to manage the interactions between the underlying hardware and user virtual machines or containers that run client software.

Distinct from user virtual machines or user executable containers, a special controller virtual machine (e.g., as depicted by controller virtual machine instance 530) or as a special controller executable container is used to manage certain storage and I/O activities. Such a special controller virtual machine is referred to as a “CVM”, or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 5D depicts a distributed virtualization system in a multi-cluster environment 5D00. The shown distributed virtualization system is configured to be used to implement the herein disclosed techniques. Specifically, the distributed virtualization system of FIG. 5D comprises multiple clusters (e.g., cluster 583₁, . . . , cluster 583_{N}) comprising multiple nodes that have multiple tiers of storage in a storage pool. Representative nodes (e.g., node 581₁₁, . . . , node 581_{1M}) and storage pool 590 associated with cluster 583₁ are shown. Each node can be associated with one server, multiple servers, or portions of a server. The nodes can be associated (e.g., logically and/or physically) with the clusters. As shown, the multiple tiers of storage include storage that is accessible through a network 596, such as a networked storage 586 (e.g., a storage area network or SAN, network attached storage or NAS, etc.). The multiple tiers of storage further include instances of local storage (e.g., local storage 591₁₁, . . . , local storage 591_{1M}). For example, the local storage can be within or directly attached to a server and/or appliance associated with the nodes. Such local storage can include solid state drives (SSD 593 . . . , SSD 593_{1M}), hard disk drives (HDD 594₁₁, . . . , HDD 594_{1M}), and/or other storage devices.

As shown, any of the nodes of the distributed virtualization system can implement one or more user virtualized entities (e.g., VE 588₁₁₁, VE 588_{11K}, VE 588_{1M1}, . . . , VE 588_{1MK}), such as virtual machines (VMs) and/or executable containers. The VMs can be characterized as software-based computing “machines” implemented in a container-based or hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 587₁₁, . . . , host operating system 587_{1M}), while the VMs run multiple applications on various respective guest operating systems. Such flexibility can be facilitated at least in part by a hypervisor (e.g., hypervisor 585₁₁, . . . , hypervisor 585_{1M}), which hypervisor is logically located between the various guest operating systems of the VMs and the host operating system of the physical infrastructure (e.g., node).

As an alternative, executable containers may be implemented at the nodes in an operating system-based virtualization environment or in a containerized virtualization environment. The executable containers are implemented at the nodes in an operating system virtualization environment or container virtualization environment. The executable containers comprise groups of processes and/or resources (e.g., memory, CPU, disk, etc.) that are isolated from the node host computer and other containers. Such executable containers directly interface with the kernel of the host operating system (e.g., host operating system 587₁₁, . . . , host operating system 587_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 590 by the VMs and/or the executable containers.

Multiple instances of such virtualized controllers can coordinate within a cluster to form the distributed storage system 592 which can, among other operations, manage the storage pool 590. This architecture further facilitates efficient scaling in multiple dimensions (e.g., in a dimension of computing power, in a dimension of storage space, in a dimension of network bandwidth, etc.).

A particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 581₁₁ can interface with a controller virtual machine (e.g., virtualized controller 582₁₁) through hypervisor 585₁₁ to access data of storage pool 590. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 592. For example, a hypervisor at one node in the distributed storage system 592 might correspond to software from a first vendor, and a hypervisor at another node in the distributed storage system 592 might correspond to a second software vendor. As another virtualized controller implementation example, executable containers can be used to implement a virtualized controller (e.g., virtualized controller 582_{1M}) in an operating system virtualization environment at a given node. In this case, for example, the virtualized entities at node 581_{1M} can access the storage pool 590 by interfacing with a controller container (e.g., virtualized controller 582_{1M}) through hypervisor 585_{1M} and/or the kernel of host operating system 587_{1M}.

In certain embodiments, one or more instances of an agent can be implemented in the distributed storage system 592 to facilitate the herein disclosed techniques. Specifically, agent 584₁₁ can be implemented in the virtualized controller 582₁₁, and agent 584_{1M} can be implemented in the virtualized controller 582_{1M}.

Instances of agent 584₁₁ and/or agent 584_{1M} can aid in ongoing management of address mappings. Furthermore, such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

Solutions attendant to accessing a virtual machine instruction via an actual direct access to memory of a remote node that holds the instruction to be fetched can be brought to bear through implementation of any one or more of the foregoing techniques. Moreover, any aspect or aspects of handling a virtual machine instruction fetch operation when the instruction to be fetched is in physical memory of a remote node can be implemented in the context of the foregoing environments.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A non-transitory computer readable medium having stored thereon a sequence of instructions which, when stored in memory and executed by a processor cause the processor to perform acts for handling memory of a virtual machine, the acts comprising:
processing a first memory command of a first virtual machine of a first virtualization system running on a first computing node, the first memory command being issued by a first CPU of the first computing node to perform an instruction FETCH of a first memory location of the first computing node; and
accessing a corresponding second memory location of a second computing node to perform the instruction FETCH issued by the first CPU.

2. The non-transitory computer readable medium of claim 1, wherein accessing the corresponding second memory location of the second computing node is accomplished using at least one interconnection fabric component.

3. The non-transitory computer readable medium of claim 1, further comprising instructions which, when stored in memory and executed by the processor cause the processor to perform further acts of:
processing a further memory command of a second virtual machine of a virtualization system running on the second computing node, the further memory command being issued by a second CPU of the second computing node to perform a READ or WRITE or further instruction FETCH of a second memory location of the second computing node; and
rather than accessing the second memory location of the second computing node, instead accessing a corresponding first memory location of the first computing node to perform the READ or the WRITE or the further instruction FETCH issued by the second CPU.

4. The non-transitory computer readable medium of claim 3, wherein accessing the corresponding first memory location of the first computing node is accomplished using at least one interconnection fabric component.

5. The non-transitory computer readable medium of claim 4, further comprising instructions which, when stored in memory and executed by the processor cause the processor to perform further acts of: copying, using the at least one interconnection fabric component, memory pages of the first virtual machine of the first computing node into physical memory of the second computing node.

6. The non-transitory computer readable medium of claim 1, further comprising instructions which, when stored in memory and executed by the processor cause the processor to perform further acts of: instantiating a copy of the first virtual machine of the first virtualization system running on the first computing node to the second computing node.

7. The non-transitory computer readable medium of claim 6 wherein at least a portion of the copy of the first virtual machine of the first virtualization system is stored in physical memory of a fabric component.

8. A method for handling memory of a virtual machine, the method comprising:
processing a first memory command of a first virtual machine of a first virtualization system running on a first computing node, the first memory command being issued by a first CPU of the first computing node to perform an instruction FETCH of a first memory location of the first computing node; and
accessing a corresponding second memory location of a second computing node to perform the instruction FETCH issued by the first CPU.

9. The method of claim 8, wherein accessing the corresponding second memory location of the second computing node is accomplished using at least one interconnection fabric component.

10. The method of claim 8, further comprising:
processing a further memory command of a second virtual machine of a virtualization system running on the second computing node, the further memory command being issued by a second CPU of the second computing node to perform a READ or WRITE or further instruction FETCH of a second memory location of the second computing node; and
rather than accessing the second memory location of the second computing node, instead accessing a corresponding first memory location of the first computing node to perform the READ or the WRITE or the further instruction FETCH issued by the second CPU.

11. The method of claim 10, wherein accessing the corresponding first memory location of the first computing node is accomplished using at least one interconnection fabric component.

12. The method of claim 11, further comprising: copying, using the at least one interconnection fabric component, memory pages of the first virtual machine of the first computing node into physical memory of the second computing node.

13. The method of claim 8, further comprising: instantiating a copy of the first virtual machine of the first virtualization system running on the first computing node to the second computing node.

14. The method of claim 13 wherein at least a portion of the copy of the first virtual machine of the first virtualization system is stored in physical memory of a fabric component.

15. A system for handling memory of a virtual machine, the system comprising:
a storage medium having stored thereon a sequence of instructions; and
a processor that executes the sequence of instructions to cause the processor to perform acts comprising,
processing a first memory command of a first virtual machine of a first virtualization system running on a first computing node, the first memory command being issued by a first CPU of the first computing node to perform an instruction FETCH of a first memory location of the first computing node; and
accessing a corresponding second memory location of a second computing node to perform the instruction FETCH issued by the first CPU.

16. The system of claim 15, wherein accessing the corresponding second memory location of the second computing node is accomplished using at least one interconnection fabric component.

17. The system of claim 15, further comprising instructions which, when stored in memory and executed by the processor cause the processor to perform further acts of:
processing a further memory command of a second virtual machine of a virtualization system running on the second computing node, the further memory command being issued by a second CPU of the second computing node to perform a READ or WRITE or further instruction FETCH of a second memory location of the second computing node; and
rather than accessing the second memory location of the second computing node, instead accessing a corresponding first memory location of the first computing node to perform the READ or the WRITE or the further instruction FETCH issued by the second CPU.

18. The system of claim 17, wherein accessing the corresponding first memory location of the first computing node is accomplished using at least one interconnection fabric component.

19. The system of claim 18, further comprising instructions which, when stored in memory and executed by the processor cause the processor to perform further acts of: copying, using the at least one interconnection fabric component, memory pages of the first virtual machine of the first computing node into physical memory of the second computing node.

20. The system of claim 15, further comprising instructions which, when stored in memory and executed by the processor cause the processor to perform further acts of: instantiating a copy of the first virtual machine of the first virtualization system running on the first computing node to the second computing node.

21. The system of claim 20 wherein at least a portion of the copy of the first virtual machine of the first virtualization system is stored in physical memory of a fabric component.
